(19) United States
(12) Patent Application Publication
(10) Pub. No.: US 2011/0012804 A1
(43) Pub. Date: Jan. 20, 2011

(54) ARRAY ANTENNA WITH RADIATING ELEMENTS DISTRIBUTED NON-UNIFORMLY IN SUBARRAYS

(75) Inventor: Christian Renard, Boulogne Billancourt (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, NEUILLY SUR SEINE (FR)

(21) Appl. No.: 12/809,605

(22) PCT Filed: Dec. 19, 2008
(86) PCT No.: PCT/EP08/68111

§ 371 Date: Sep. 13, 2010

(30) Foreign Application Priority Data
Dec. 21, 2007 (FR) 07/09032

(51) Int. Cl. H01Q 21/08

(52) U.S. Cl. 343/824

(57) ABSTRACT

An array antenna includes radiating elements distributed in sub-arrays, the sub-arrays being fed via substantially identical amplifiers operating at an identical level. The radiating elements of one and the same sub-array are distributed non-uniformly in space, the distance between two adjacent radiating elements being dependent on the law of illumination desired for said array antenna and the technical characteristics of the sub-arrays.

The invention is directed at array antennas, and more particularly at so-called active array antennas.

Generally, array antennas consist of identical radiating elements (or radiating sources). Conventionally, in the case of linear array antennas (that is to say having their radiating elements aligned), the sources are equidistant.

Moreover, these sources are fed with the same voltage value. Stated otherwise, a uniform weighting law is applied to all the radiating sources. This law results in a radiation pattern exhibiting high sidelobes. It is recalled that a radiation pattern corresponds to the Fourier transform of the law of illumination of the array antenna which itself expresses the distribution of the luminous power of the antenna at various places, around the antenna.

An optimal law of illumination has a regular growth between each end of the array antenna and its center. The optimum of the luminous power is attained near the center of the linear array antenna. The presence of sidelobes of large amplitude in the radiation pattern of the antenna under study corresponds to a law of illumination that is very far removed from an optimal law.

In systems incorporating this type of array antenna, small sidelobes are frequently advocated, for example when transmitting a signal. This makes it possible to avoid any loss of power in angular directions other than the useful direction of radiation (main lobe of the antenna) or else for reasons of electromagnetic pollution (when part of the power of the signal transmitted is dispersed in an undesired direction).

In the case where the antenna operates as receiver, it is also preferable to avoid the presence of sidelobes of large amplitude within the radiation pattern, so as to circumvent any risk of disturbance by intentional or unintentional wave jammers.

It is nonetheless possible to limit the amplitude of these sidelobes by applying a suitable weighting to the sources of the array antenna, with the aid for example of a Gauss, Taylor or Chebyshev law, these laws being well known to the person skilled in the art. They involve a modulation of the amplitude of the voltage delivered to the radiating elements.

A so-called active array antenna comprises distributed amplification in its architecture, that is to say radiofrequency amplification elements are positioned between the input point of the array antenna and the radiating elements constituting said array antenna. These amplification elements (or amplifiers) are generally modules that can be used both for reception and for transmission. They sometimes comprise phase shift elements for pointing the beam transmitted by the array antenna in directions other than the normal to the array antenna.

On transmission, the power that can be delivered by the aforementioned modules is limited by the technology. It may not exceed a certain level related to the saturation point of the amplification element.

For an active antenna, the power radiated is limited by the sum of the powers delivered as outputs from the radiofrequency amplification elements. For a given number of radiofrequency amplification elements, it is preferable that these elements operate with a maximum output power, that is to say at saturation.

For an array antenna of active type consisting of identical modules, the output power of the modules is also identical.

If a weighting of the law of illumination is applied by modulating the power of the radiofrequency amplification elements, the power delivered (on transmission) by those situated at the ends of the array antenna is reduced.

Consequently, the weighting thus performed gives rise to a loss of the total power generated by the array antenna.

Moreover, for an array antenna of active type in receive mode, its sensitivity is related to the gain of the array antenna (therefore to its dimension) and to the noise generated by the array antenna. This noise must therefore be minimal. If a weighting of the law of illumination is performed with the aid of attenuators positioned downstream of the amplifiers, there is an increase in the noise generated by the array antenna. The sensitivity of the antenna is consequently decreased.

It is possible to perform the weighting in question, in a fixed manner by a summator of signals forming the useful channels of the array of the antenna operating as receiver. But in this case, the radiofrequency divider dedicated to the distributing of the signal when the array antenna operates in transmit mode may not be used for the summation of the signals when the array antenna is used as receiver. A circuit specifically suited to the reception of signals must then be installed within the antenna.

This comprises numerous disadvantages: the array antenna is bulky; it is necessary to add an additional channel to install the array of radiating elements forming the antenna under consideration; the overall architecture of the array antenna is made more complex; its mass and its manufacturing cost increase.

Another known technique for performing a weighting of the amplitude of the power radiated by the antenna is to form sub-arrays of radiating elements. Stated otherwise, the radiating elements are grouped together block-wise, each block comprising more or fewer radiating elements. Each of these sub-arrays is fed via an amplifier, all the amplifiers used within the array antenna being identical.

The number of radiating elements that each sub-array comprises varies as a function of the mean power that it is desired that the radiating element release in the case where the antenna operates in transmit mode. Indeed, as each sub-array is linked to the same amplifier, the same voltage value is delivered to each sub-array. Consequently, the more radiating elements the sub-array comprises, the lower the power radiated by each of these elements.

However, the law of illumination obtained with this type of array antenna comprises tiers or step changes. For example, it may be low over a first portion of the antenna, pass to a maximum value over a second portion of the antenna and then revert to a low value over a last portion of the antenna. This law of illumination involves an upswing in the sidelobes, this being particularly harmful for array antennas of small dimension.

The invention is notably directed at affording a solution to these problems.

An aim of the invention is to propose an array antenna, in particular an active array antenna having a desired law of illumination, stated otherwise an optimal law of illumination for the use made of the array antenna considered.

For this purpose, there is proposed an array antenna comprising radiating elements distributed in sub-arrays, the sub-arrays being fed via substantially identical amplifiers operating at identical level on transmission.

According to a general characteristic of the invention, the radiating elements of one and the same sub-array are distributed non-uniformly in space, the distance between two adjacent radiating elements being dependent on the law of illumination desired for said array antenna and the technical characteristics of the sub-arrays.

Preferably, the discrepancy between two radiating elements is proportional to the wavelength of the signal transmitted by said array antenna.

Stated otherwise, the radiating elements are distributed as a function of the desired law while taking account of the technical characteristics of the sub-arrays. The power transmitted or received by the array antenna is thus spatially weighted without modifying the power delivered by the amplifiers used for feeding the radiating elements.

For example, a technical characteristic of a sub-array can be the number of radiating elements that it comprises.

Preferably, the sub-arrays located at the center of the array antenna comprise fewer radiating elements than the sub-arrays situated at its ends.

According to one embodiment, the position of a radiating element of rank i within said array antenna, i being an integer, can be determined in such a way that the power density of said radiating element of rank i is substantially equal to the power density of a radiating element also of rank i incorporated within an array antenna having a uniform distribution of its radiating elements, and the power transmitted or received by each of whose radiating elements corresponds to the desired law of illumination.

According to one embodiment, the radiating elements can be disposed linearly.

According to another embodiment, the sub-arrays can be distributed along two orthogonal directions.

Other advantages and characteristics of the invention will be apparent on examining the detailed description of the wholly non-limiting embodiments of the invention and the appended drawings in which:

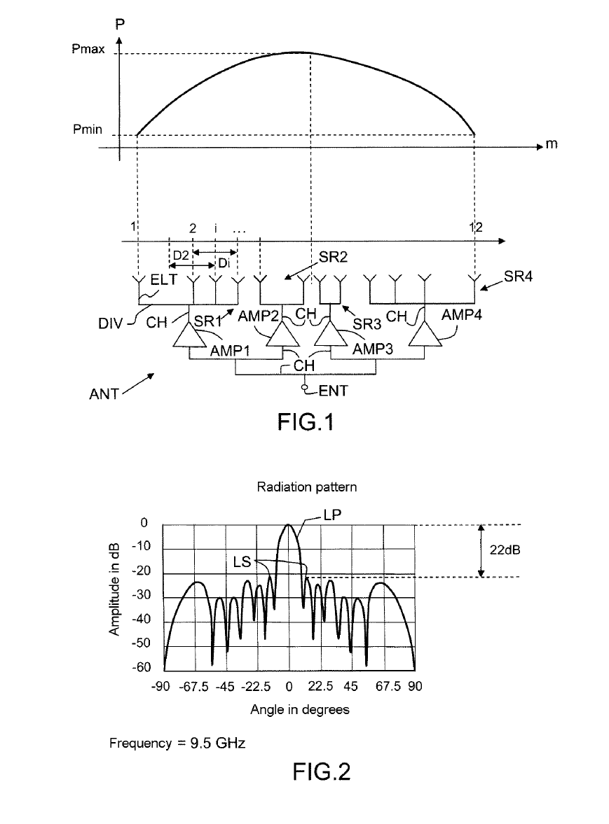

FIG. 1 illustrates a law of illumination of an array antenna of active type according to the invention; and

FIG. 2 represents an example of a radiation pattern of an array antenna according to the invention.

FIG. 1 is referred to. The upper part of FIG. 1 represents an exemplary law of illumination of an array antenna ANT represented in the lower part, when the latter operates in transmit mode. The law of illumination corresponds to the variation of the mean power Pi radiated by the various radiating elements of an array antenna according to the invention, here the array antenna ANT illustrated in the lower part of FIG. 1.

This variation is therefore a function of a distance (here in meters, m).

The law of illumination represented passes from a very low value Pmin for the radiating element situated at the first end of the array antenna, to a maximum value Pmax at the center of the antenna, and then reverts to the low value Pmin at the second end of the array antenna ANT. The variation from the minimum value Pmin to the maximum value Pmax, and vice versa, takes place in a progressive manner.

The array antenna ANT represented in the lower part of FIG. 1 here comprises twelve identical radiating elements ELT. They are distributed in four sub-arrays SR1, SR2, SR3 and SR4. The sub-arrays SR1 and SR4 disposed at the ends of the array antenna ANT each comprise four radiating elements, while the two sub-arrays of the center SR2 and SR3 comprise two radiating elements respectively.

As may be seen in the lower part of FIG. 1, the spacing between two radiating elements ELT is not equidistant. Each sub-array SR1, SR2, SR3 and SR4 possesses its own spatial distribution of the radiating elements ELT that it incorporates. The general aspect of this spatial distribution internal to the sub-arrays culminates in radiating elements that are more tightly spaced at the center of the array antenna ANT than at its ends and, in each sub-array, more tightly spaced the nearer one gets to the center of the antenna ANT. This distribution results in the law of illumination represented in the upper part of FIG. 1.

Each sub-array SR1, SR2, SR3 and SR4 is fed via a radiofrequency amplifier, respectively referenced AMP1, AMP2, AMP3 and AMP4, connected at the input ENT of the array antenna ANT. They are able to operate both during the transmission and during the reception of a signal by the array antenna ANT.

The various elements are coupled together by way of an electrical path CH forming a summator when the array antenna ANT receives a signal, and a divider when the antenna transmits a signal. It is considered here that the lengths between each output of the amplifiers and the radiating elements to which they are linked are identical. Each amplifier AMP1, AMP2, AMP3 and AMP4 delivers the same voltage value to the sub-array to which it is connected, namely its saturation value.

Because of its sub-array architecture, the array antenna ANT effects a block-wise weighting on the power radiated by its radiating elements ELT. To this power is added a spatial distribution inside each sub-array SR1, SR2, SR3 and SR4. Therefore, when the array antenna ANT operates in transmit mode, the radiated local power density (that is to say the power radiated per unit length, for example a meter, around the radiating element considered) by a radiating element ELT is a function:
of the power feeding the element,
of the surface area occupied by the radiating element considered, this area being dependent on the distance to the neighboring radiating elements,
of the total number of radiating elements incorporated in the sub-array to which it belongs.

Thus for a given feed power, the more the separation between the radiating element considered and its neighbors is reduced and the more the sub-array incorporating the radiating element comprises a low number of radiating elements, the more significant then is the local radiation density. It is said in this case that the radiating elements ELT possessing a significant radiated local power density are assigned a more significant weight than that of the other elements.

Likewise, when the array antenna ANT operates in receive mode, the radiating elements ELT belonging to a zone of the array antenna ANT where they are more tightly spaced possess a larger weight than the other elements.

More precisely, the position of each radiating element is calculated by considering the power density afforded by a radiating element integrated within a passive array antenna. Unlike an active array antenna, a passive array antenna does not comprise any amplifier downstream of its radiating elements, which are for their part distributed in a regular manner.

For an array antenna considered on transmission, the radiating element of rank i, positioned at the center of a segment of length Di (corresponding to the local spacing of the non-uniform sub-array), it follows that:

Dᵢ=D₀Pᵢ/Pweightᵢ, where
D₀ is the spacing between two sources of a regular array,
Pᵢ=P₀/Nᵢ such that P₀ is the power provided by the amplifier linked to the radiating element of rank i and Nᵢ is the number of elements within the sub-array considered, and
Pweightᵢ is the desired equivalent power, corresponding to the application of the desired weighting law in regard to the position corresponding to the element i of an array antenna whose radiating elements are uniformly distributed. An optimization can be performed, in particular at the places where the type of coupler changes, that is to say at the junctions between two sub-arrays. This optimization makes it possible to counteract the spurious cuttings between two radiating elements, in particular between two radiating elements belonging to two adjacent ends of two distinct sub-arrays. This optimization can be likened to a smoothing of the power transmitted (in the case of transmission).

An exemplary radiation pattern obtained with an array antenna according to the invention is represented in FIG. 2. The first sidelobes LS are situated about 22 dB below the main lobe LP.

Of course, the array antenna can be linear as in the example described above, but also be two-dimensional. The position of the radiating elements is then defined along two orthogonal directions on the surface of the antenna.

Two architectures are then possible:
the law of illumination is separable along these two orthogonal directions and the amplifiers are connected via dividers to linear sub-arrays of radiating elements. The antenna can be considered to be the stack (that is to say a side by side arrangement) of linear arrays split up into sub-arrays and with spatial weighting in each sub-array such as described above, or
the amplifiers are connected via dividers to two-dimensional sub-arrays of radiating elements; in this case, a split into surface sub-arrays and an adjustment of the position of the sources along the two orthogonal directions on the surface of the array antenna are considered.

1. An array antenna comprising radiating elements distributed in sub-arrays, the sub-arrays being fed via substantially identical amplifiers operating at an identical level on transmission, said radiating elements of one and the same sub-array being distributed non-uniformly in space, the distance between two adjacent radiating elements being dependent on the law of illumination desired for said array antenna and the technical characteristics of the sub-arrays.

2. The array antenna as claimed in claim 1, wherein a technical characteristic of a sub-array is the number of radiating elements that it comprises.

3. The array antenna as claimed in claim 1, wherein the sub-arrays located at the center of the array antenna comprise fewer radiating elements than the sub-arrays situated at its ends.

4. The array antenna as claimed in claim 1, wherein the position of a radiating element of rank i within said array antenna, i being an integer, is determined in such a way that the power density of said radiating element of rank i is substantially equal to the power density of a radiating element also of rank i incorporated within an array antenna having a uniform distribution of its radiating elements, and the power transmitted or received by each of whose radiating elements corresponds to the desired law of illumination.

5. The array antenna as claimed in claim 1, in which the discrepancy between two radiating elements is proportional to the wavelength of the signal transmitted by said array antenna.

6. The array antenna as claimed in claim 1, wherein the radiating elements are disposed linearly.

7. The array antenna as claimed in claim 1, wherein the sub-arrays are distributed along two orthogonal directions.
